(19) United States
(12) Patent Application Publication
(10) Pub. No.: US 2009/0070198 A1
(43) Pub. Date: Mar. 12, 2009

(54) STUDIO FARM

(75) Inventor: Richard Berger, Culver City, CA (US)

Correspondence Address: PROCOPIO, CORY, HARGREAVES & SAVITCH LLP, 530 B STREET, SUITE 2100, SAN DIEGO, CA, 92101, US

(73) Assignees: SONY CORPORATION, Tokyo (JP); Sony Pictures Entertainment Inc., Culver City, CA (US)

(21) Appl. No.: 12/209,886

(22) Filed: Sep. 12, 2008

Related U.S. Application Data
(60) Provisional application No. 60/971,870, filed on Sep. 12, 2007.

(51) Int. Cl. G06Q 30/00; G06Q 50/00

(52) U.S. Cl. 705/10

(57) ABSTRACT

A method for reviewing and developing media content, including: receiving the media content submitted by a media creator; enabling reviewers to view and rate the media content; receiving ratings of a plurality of media contents from the reviewers; selecting at least one media content from the plurality of media contents based on the ratings; and disseminating the at least one media content.

### CROSS-REFERENCE TO RELATED APPLICATIONS

This application claims the benefit of priority pursuant to 35 U.S.C. §119 of co-pending U.S. Provisional Patent Application No. 60/971,870, filed Sep. 12, 2007, entitled “Studio Farm.” The disclosure of the above-referenced provisional application is incorporated herein by reference.

### BACKGROUND

The present invention relates generally to reviewing and developing media content, and more particularly to viewing and rating the media content, and disseminating based on the rating.

A typical content provider has difficulty providing enough content for a broadband video channel on the web. Aggregating content from other commercial sources (e.g., studios) or creating enough new original content is costly, difficult, and time-consuming.

### SUMMARY

Certain implementations as disclosed herein provide for viewing and rating media content, and disseminating based on the rating.

In one aspect, a method for reviewing and developing media content is disclosed. The method includes: receiving the media content submitted by a media creator; enabling reviewers to view and rate the media content; receiving ratings of a plurality of media contents from the reviewers; selecting at least one media content from the plurality of media contents based on the ratings; and disseminating the at least one media content.

In another aspect, a studio farm system is disclosed. The system includes: a service provider configured to: receive the media content submitted on media files by a media creator; enable reviewers to view and rate the media content; receive ratings of a plurality of media contents from the reviewers; select at least one media content from the plurality of media contents based on the ratings; a media dissemination service configured to disseminate the at least one media content.

In yet another aspect, a computer-implemented method is disclosed. The method includes: receiving media files submitted by media creators; providing access to the media files to reviewers for viewing and ratings; receiving the ratings of the media files made by the reviewers; selecting media items from the media files based on the ratings; and disseminating the selected media items.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which:

FIG. 1 is a functional block diagram of a “studio farm” system for reviewing and developing media content in accordance with one implementation;

FIG. 2 is a flowchart describing a method for reviewing and developing media content in accordance with one implementation;

FIG. 3A illustrates a representation of a computer system and a user; and

FIG. 3B is a functional block diagram illustrating the computer system hosting the studio farm system.

### DETAILED DESCRIPTION

Certain implementations of the present invention as disclosed herein implement a technique for reviewing and developing content. After reading this description it will become apparent to one skilled in the art how to practice the invention in various alternative implementations and alternative applications. However, although various implementations of the present invention will be described herein, it is understood that these embodiments are presented by way of example only, and not limitation. As such, this detailed description of various alternative implementations should not be construed to limit the scope or breadth of the present invention as set forth in the appended claims.

In one implementation, users or media creators submit media content (e.g., digital video files) to a service provider. Examples of media content include, but are not limited to: digital video files, digital audio files, multimedia files, and text files. The submission may be made using a media channel or service (e.g., through a website). Other users or reviewers then access and rate the media content contained in media files. The ratings lead to tiered categories of content. Thus, different tiers provide different benefits.

In one implementation, the submissions of the media content become the property of the service provider and the service provider repackages or provides access to selected items (e.g., top tier items) through another media channel or service. For example, the service provider may operate a separate second online media service that provides high quality video/audio and the service provider can provide media from the top tier of the submitted media content in this second service. In another example, the service provider may sell and/or rent physical media (e.g., DVDs) storing media from the top tier. In another example, the service provider pays the source of top ranked media, such as prize money or payment for future video/audio and/or episodes.

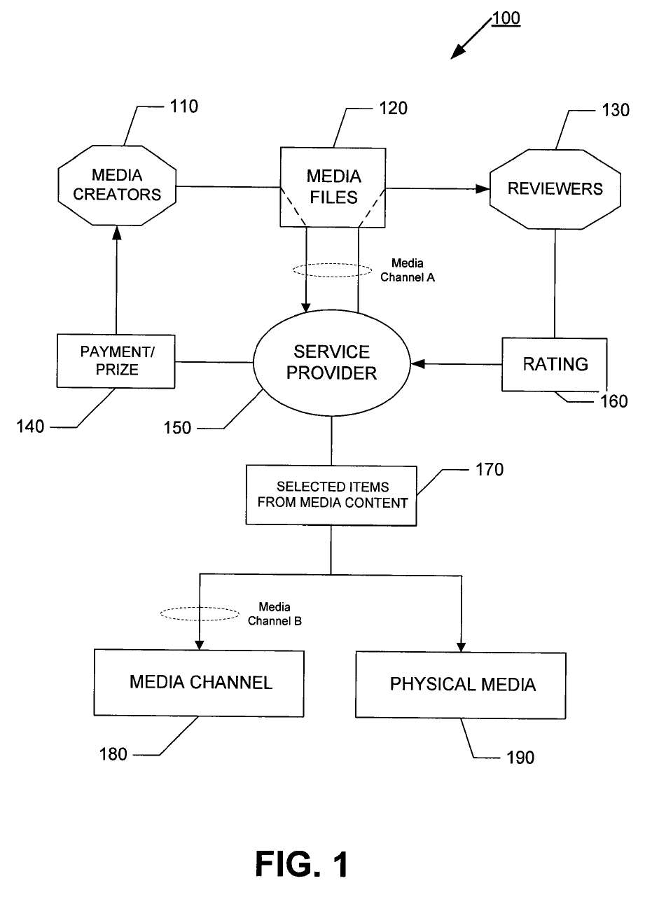

One implementation illustrated in FIG. 1 includes a “studio farm” system 100 for reviewing and developing media content. The studio farm system 100 enables media creators 110 to submit media content (e.g., digital video content) stored in media files 120 to the service provider 150 (e.g., using Media Channel A). In one implementation, a category for the media content is selected by the media creator 110 at the time of submission. For example, categories include comedy, animation, sponsored media, video log (“VLOG”), and/or other related media categories.

The submitted media files are then made available to a community of reviewers 130 to view and rate the media content. In one implementation, the reviewers 130 are persons and/or entities different from the media creators 110. In another implementation, the reviewers 130 are persons and/or entities with “first-look” rights. These reviewers include independent producers, professional consumers (“prosumers”), and/or media enthusiasts. In other examples, some content is reviewed by a limited set of reviewers while other content is reviewed by the public, some or all content is reviewed in stages, or some content is reviewed by different groups of people for different purposes (e.g., a professional review for purchasing evaluation and a public review for awards).

The ratings 160 made by the reviewers 130 are submitted to the service provider 150. In one implementation, high ratings provide the media creators 110 with eligibility for special review of subsequent content, and the top rated content is eligible for dissemination on the Web (e.g., on a different website or service). In one case, the special review may involve automatic bump up in ratings (e.g., by one level) for a review of subsequently submitted content by the same media creator. In another case, the special review may involve automatic submission of the subsequent content to the service provider without being submitted to the reviewers. Thus, new talent and source content may be farmed from the media content on the Web. In one example, subsequent content eligible for special review includes a following episode of a series. Further episodes of top rated content may be commissioned by the service provider.

In the illustrated implementation of FIG. 1, selected items from the rated media content 170 are obtained/purchased from the media creator 110 and disseminated. In one implementation, the service provider 150 selects items for dissemination based on the ratings 160 made by the reviewers 130. The ratings 160 lead to tiered categories of content, where the top tier items are selected for dissemination. For example, the top tier items include the top 10% of the media content rated by the reviewers. In another example, the top tier items include the top 10% of the media content that is rated as the funniest. In another implementation, the service provider 150 selects items for dissemination based on certain criteria preset by the service provider 150, as well as on the ratings 160 made by the reviewers 130. The preset criteria may be tailored for business opportunities for the service provider 150. For example, if the service provider 150 desires to promote the business of motion pictures, the preset criteria may include funny motion picture advertisements or short clips (to be shown before movie presentations).

In one implementation, the service provider 150 repackages or provides access to the selected items through a media channel or service 180 (e.g., using Media Channel B). In this implementation, the service provider 150 disseminates content on the Web over a broadband media channel 180 and/or physical media 190. For example, the service provider 150 may operate a separate online media service that provides high-quality media content. In another example, the service provider 150 may sell or rent physical media (e.g., DVDs or Blu-ray Discs) 190 storing the selected items from the media content 170.

The content may include various types and levels of quality of content, such as original content short items from individual users or high-quality and independently commissioned series from groups of people, including short-form TV-like episodes (“webisodes”). In one example, dissemination on the Web includes on-demand streaming and downloads for portable devices, including, for example, mobile phones. In another example, the disseminated content may be ad-supported.

In another implementation, the service provider 150 pays the source of the selected media items, such as prize money or payment 140 for the use of the selected items or for future submission of video/audio and/or episodes by the source. The determination of whether to award prize money can be based on a different review than that for determining whether to pay for additional content. For example, a “people's favorite” award could be given for an item that has received very high reviews among the general users of the website. Similarly, “critic's choice” awards could be given out by selected reviewers (e.g., staff of the service provider or selected members of the public, such as approved users who have submitted a certain number of reviews). A payment for use can be a payment to use the submitted content, payment in advance for a specified amount of content, or a payment for non-specified future content (similar to a grant). In some implementations, any content submitted to the service provider is submitted with an agreement that all ownership in the content is transferred to the service provider (or designated entity) and so any payment received is bonus or supplemental compensation.

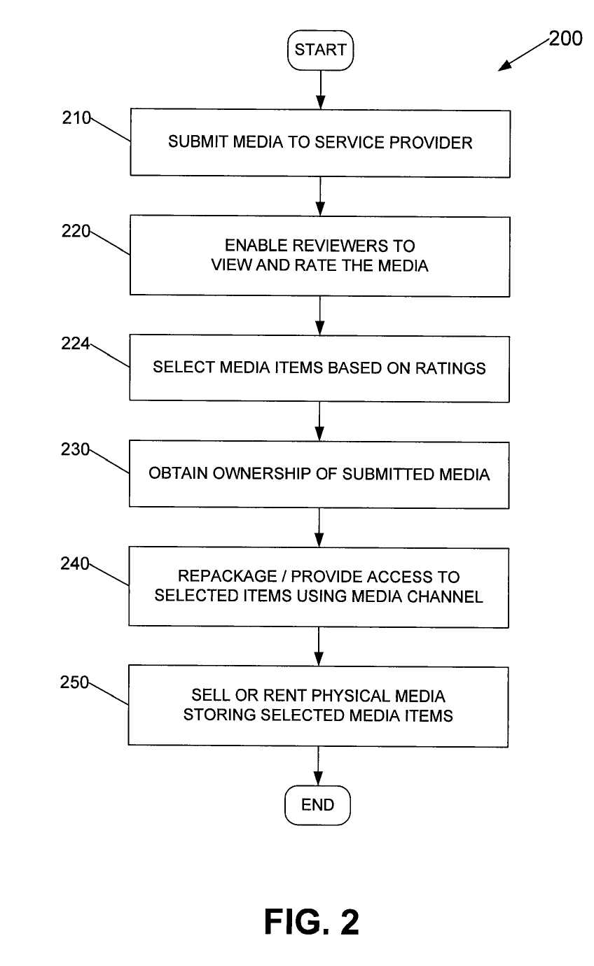

FIG. 2 is a flowchart 200 describing a method for reviewing and developing media content in accordance with one implementation of the present invention. In this implementation, media creators 110 submit media content (e.g., digital video content) stored in media files 120 to the service provider 150, at box 210. In one implementation, a category for the media content is selected by the media creators 110 at the time of submission. In another implementation, reviewers provide category information. For example, categories include comedy, animation, sponsored media, video log (“VLOG”), or other related media categories. Similarly, other metadata can also be stored for a submission (e.g., author, date of submission, media type, etc.).

At box 220, the submitted media files are then made available to a community of reviewers 130 by enabling the reviewers (e.g., other users) to view and rate the media content. The ratings 160 made by the reviewers 130 are submitted to the service provider 150. In one implementation, high ratings provide the media creators 110 with eligibility for special review of subsequent content, and the top rated content is eligible for dissemination on the Web. In one case, the special review may involve automatic bump up in ratings (e.g., by one level) for a review of subsequently submitted content by the same media creator. In another case, the special review may involve automatic submission of the subsequent content to the service provider without being submitted to the reviewers. Further, if a submission is rated highly by reviewers, the service provider may select that submission for wider distribution (e.g., through another service or physical media) or for further development and make an arrangement with the author for additional submissions. Thus, new talent and source content may be farmed from the media content on the Web.

In the illustrated implementation of FIG. 2, the service provider 150 selects, at box 224, media items from the media content based on the ratings 160 made by the reviewers 130. The service provider 150 then obtains ownership of the submitted media content, at box 230, including the items of the media content selected by the service provider based on the ratings 160. The selected items of the media content are disseminated by: repackaging and providing access to the selected items of the media content using a media channel 180, at box 240; or selling or renting physical media 190, at box 250.

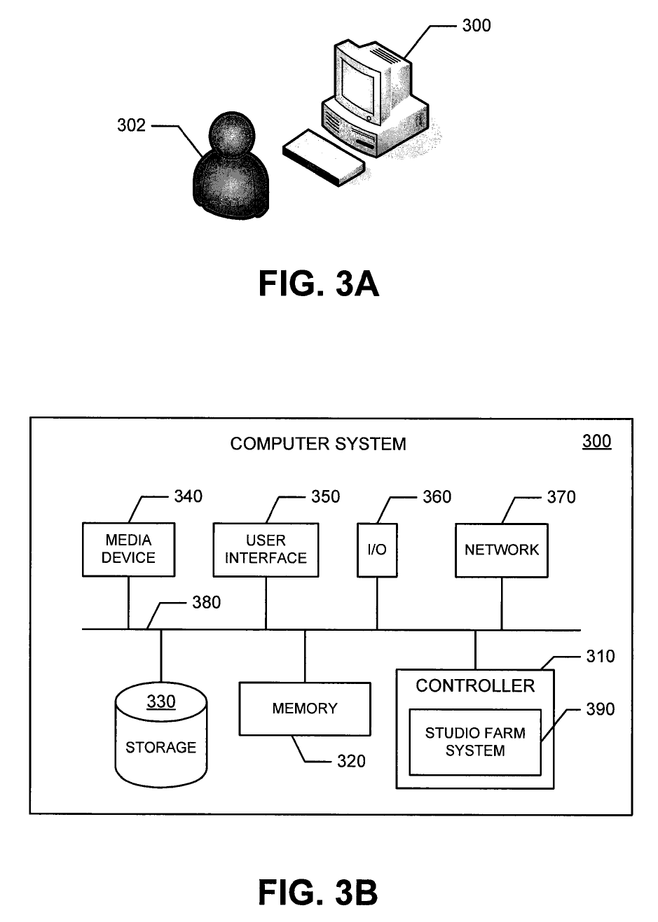

FIG. 3A illustrates a representation of a computer system 300 and a user 302. The user 302 uses the computer system 300 to implement a technique for reviewing and developing media content. The computer system 300 stores and executes a “studio farm” system 390, which reviews and develops media content for dissemination.

FIG. 3B is a functional block diagram illustrating the computer system 300 hosting the studio farm system 390. The controller 310 is a programmable processor and controls the operation of the computer system 300 and its components. The controller 310 loads instructions (e.g., in the form of a computer program) from the memory 320 or an embedded controller memory (not shown) and executes these instructions to control the system. In its execution, the controller 310 provides the studio farm system 390 as a software system. Alternatively, this service can be implemented as separate components in the controller 310 or the computer system 300.

Memory 320 stores data temporarily for use by the other components of the computer system 300. In one implementation, memory 320 is implemented as RAM. In one implementation, memory 320 also includes long-term or permanent memory, such as flash memory and/or ROM.

Storage 330 stores data temporarily or long term for use by other components of the computer system 300, such as for storing data used by the studio farm system 390. In one implementation, storage 330 is a hard disk drive.

The media device 340 receives removable media and reads and/or writes data to the inserted media. In one implementation, for example, the media device 340 is an optical disc drive.

The user interface 350 includes components for accepting user input from the user of the computer system 300 and presenting information to the user. In one implementation, the user interface 350 includes a keyboard, a mouse, audio speakers, and a display. The controller 310 uses input from the user to adjust the operation of the computer system 300.

The I/O interface 360 includes one or more I/o ports to connect to corresponding I/O devices, such as external storage or supplemental devices (e.g., a printer or a PDA). In one implementation, the ports of the I/O interface 660 include ports such as: USB ports, PCMCIA ports, serial ports, and/or parallel ports. In another implementation, the I/O interface 360 includes a wireless interface for communication with external devices wirelessly.

The network interface 370 includes a wired and/or wireless network connection, such as an RJ-45 or “Wi-Fi” interface (including, but not limited to 802.11) supporting an Ethernet connection.

The computer system 300 includes additional hardware and software typical of computer systems (e.g., power, cooling, operating system), though these components are not specifically shown in FIG. 3B for simplicity. In other implementations, different configurations of the computer system can be used (e.g., different bus or storage configurations or a multi-processor configuration).

Various illustrative implementations of the present invention have been described. However, one of ordinary skill in the art will recognize that additional implementations are also possible and within the scope of the present invention. For example, the service provider may not be actively involved in the selection of the media items from the submitted media content. Instead, the service provider may merely facilitate the dissemination of the selected items of the media content. In this case, the selection is done automatically.

Accordingly, the present invention is not limited to only those embodiments described above.

What is claimed is:

1. A method for reviewing and developing media content, comprising:
receiving the media content submitted by a media creator;
enabling reviewers to view and rate the media content;
receiving ratings of a plurality of media contents from the reviewers;
selecting at least one media content from the plurality of media contents based on the ratings; and
disseminating the at least one media content.

2. The method of claim 1, further comprising
obtaining ownership of the submitted media content including the at least one media content.

3. The method of claim 1, wherein said disseminating the at least one media content comprises
providing access to at least one media content through a media channel.

4. The method of claim 1, wherein said disseminating the at least one media content comprises
at least one of selling and renting physical media that stores the at least one media content.

5. The method of claim 1, further comprising
selecting a category for the media content at the time of submission by the media creator.

6. The method of claim 5, wherein the category includes
at least one of comedy, animation, sponsored media, and video log (“VLOG”).

7. The method of claim 1, wherein receiving high ratings from the reviewers entitles the media creator with eligibility for a special review of subsequent content.

8. The method of claim 7, wherein the special review includes automatic bump up in ratings for a review of subsequently submitted content by the same media creator.

9. The method of claim 7, wherein the subsequent content eligible for review includes
a following episode of a series.

10. The method of claim 1, further comprising
paying or awarding prizes for the use of the submitted media content.

11. The method of claim 1, further comprising
paying or awarding prizes for the use of the at least one media content selected from the plurality of media contents.

12. The method of claim 1, wherein said selecting at least one media content from the plurality of media contents is additionally based on other preset criteria.

13. A studio farm system, comprising:
a service provider configured to:
receive the media content submitted on media files by a media creator;
enable reviewers to view and rate the media content;
receive ratings of a plurality of media contents from the reviewers;
select at least one media content from the plurality of media contents based on the ratings;
a media dissemination service configured to disseminate the at least one media content.

14. The system of claim 13, wherein said media dissemination service comprises
a media channel configured to provide access to the at least one media content.

15. The system of claim 14, wherein said media channel includes
on-demand streaming and downloads for portable devices.

16. The system of claim 13, wherein said media dissemination service comprises
physical media configured to store the at least one media content.

17. A computer-implemented method, comprising:
receiving media files submitted by media creators;
providing access to the media files to reviewers for viewing and ratings;
receiving the ratings of the media files made by the reviewers;
selecting media items from the media files based on the ratings; and
disseminating the selected media items.

18. The computer-implemented method of claim 17, wherein said disseminating the selected media items comprises
providing access to the selected media items using a media channel.

19. The computer-implemented method of claim 17, wherein the ratings lead to tiered categories of the media content.

20. The computer-implemented method of claim 17, wherein top tiers of the media content are selected for dissemination.

21. The computer-implemented method of claim 17, further comprising
paying or awarding prizes for the use of the selected media items.
